(19) United States
(12) Patent Application Publication
(10) Pub. No.: US 2025/0135425 A1
(43) Pub. Date: May 1, 2025

(54) DEVICE AND METHOD FOR THE PRODUCTION OF SILICON CARBIDE

(71) Applicant: The Yellow SiC Holding GmbH, Berlin (DE)

(72) Inventor: Siegmund GREULICH-WEBER, Berlin (DE)

(73) Assignee: The Yellow SiC Holding GmbH, Berlin (DE)

(21) Appl. No.: 18/835,044

(22) PCT Filed: Jan. 27, 2023
(86) PCT No.: PCT/EP2023/052089

§ 371 Date: Aug. 1, 2024

(30) Foreign Application Priority Data
Feb. 1, 2022 (DE) 10 2022 102 320.6

(51) Int. Cl. B01J 8/12; B01J 8/08; C01B 32/97

(52) U.S. Cl. CPC B01J 8/12; B01J 8/087; C01B 32/97; B01J 2208/0053; B01J 2208/00769; B01J 2208/0084; B01J 2208/00938

(57) ABSTRACT

Disclosed is an apparatus for the production of silicon carbide which comprises a heatable reactor (1) which has a feed opening (4) on its upper side for continuous feeding with a precursor (7), an outlet opening (5) on its lower side for the continuous exit of silicon carbide (10) formed in the reactor (1) from the precursor, and an internal space (3) between the feed opening (4) and the outlet opening (5), wherein the feed opening, outlet opening and internal space are arranged such that the precursor and silicon carbide can pass through the internal space (3) falling from the feed opening (4) to the outlet opening (5).

The invention relates to an apparatus and a method for the production of silicon carbide, in particular for the production of silicon carbide powder.

Silicon carbide is an attractive material for many uses due to its high hardness, its thermal conductivity and its special semiconductor properties. However, many of these properties are impaired by impurities. Silicon carbide of high-purity is required for processing in the semiconductor industry in particular.

Silicon carbide is typically produced from a precursor containing Si and C by means of carbothermal reactions in a reactor (furnace) at high temperatures. Examples of the precursor are powders or granules of SiO₂ and carbon-containing components.

A well-known method for the production of silicon carbide is the Acheson process, in which the silicon carbide is obtained in batches from silicon dioxide in the form of quartz sand and from carbon in the form of coke in an electric resistance furnace at temperatures of more than 2000° C.

EP 0476422 A1 discloses a method for the production of silicon carbide from silicon dioxide powder and carbon black under argon in a crucible or rotary kiln at temperatures of 1200 to 2000° C. over a period of one hour.

These methods are batch processes in which the SiC is produced in batches from a quantity of precursor previously loaded into the reactor. However, batch processes are dissatisfactory for the industrial production of SiC because the quantity in a batch is limited. Reloading the precursor is time-consuming and involves a loss of energy due to the cooling and reheating of the reactor and makes it difficult to precisely control the process parameters over the entire production time.

In addition, the silicon carbide produced in the known manner is not pure enough for many uses, for example in the manufacture of electronics or semiconductors, and must be cleaned at great expense before being further processed.

It is, therefore, an object of the invention to provide an apparatus and a method for the production of silicon carbide which are more efficient than the prior art.

This object is solved by an apparatus and a method for the production of silicon carbide as set forth in the appended claims.

The invention allows continuous production of silicon carbide in a reactor in which the precursor is transformed into silicon carbide as it falls through the reactor. The precursor and the silicon carbide hardly come into contact with the reactor wall. As a result, practically, there is no contamination of the silicon carbide produced in the reactor. The absorption of foreign substances by the precursor and by the silicon carbide produced is limited by the relatively short passage or dwell time during their fall through the reactor. The invention is ideally suited for the efficient production of silicon carbide of high purity.

The passage or dwell time during the fall through the reactor is well suited to transform a nano- or microscale precursor into nano- or microcrystalline silicon carbide powder. Nanoscale or microscale here refers to the size of the primary particles in the precursor, i.e. to particle sizes in the range from 5 to 1000 nm, typically around 20 to 200 or up to 1000 nm, or to particle sizes in the range from 1 to 1000 μm, typically around 1 or 20 to 200 μm.

The properties from the invention cannot be achieved with horizontal rotary kilns as in the prior art. The rotary kiln would have to be made of high-purity silicon carbide to avoid the introduction of other materials into the product and provide the purity required for production of high-quality silicon carbide. This would be expensive and technically almost impossible to realize. Further, the furnace chamber should be filled with inert gas and sealed off from the outside atmosphere to produce silicon carbide of high purity. In rotary kilns, however, it is difficult to seal the moving parts at temperatures of even around 1800° C. to 2000° C. Sealing the moving parts so that the precursor can still be fed in and out would hardly be technically possible. In addition, the passage times of the precursor through conventional rotary kilns for silicon carbide production are too long. None of these problems occur with the invention.

Preferred embodiments of the invention are described below with reference to the drawing in which:

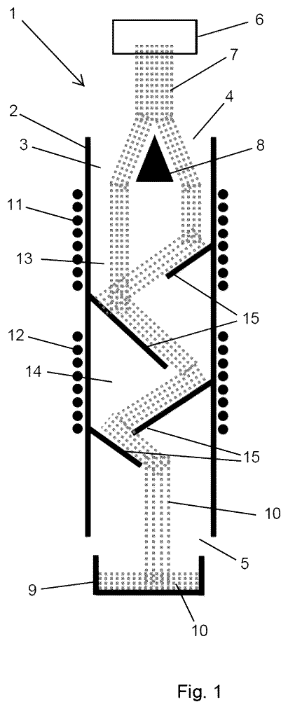

FIG. 1 shows an apparatus for the production of silicon carbide according to the embodiments.

In the following, references to direction and orientation such as “upper” and “lower” refer to the orientation of the apparatus when used as intended in the method for the production of silicon carbide.

The apparatus shown in FIG. 1 for the production of silicon carbide comprises a furnace being a heatable reactor 1. The reactor 1 comprises a jacket 2, which surrounds an internal space 3 and has a feed opening 4 at the upper end of the internal space 3 on the upper side or top of the reactor 1 and an outlet opening 5 at the lower end of the internal space 3 on the lower side or bottom of the reactor 1. In this embodiment, the jacket 2 is formed essentially as a vertical tube. The feed opening 4 and the outlet opening 5 lie essentially vertically one above the other. The internal space 3 is preferably filled with an inert gas, for example argon.

A feed device 6 for feeding a precursor 7 through the feed opening 4 into the internal space 3 is arranged above the feed opening 4. In this arrangement, the precursor trickles through the feed opening 4 into the internal space 3 due to gravity. The feed opening 4 is provided with a divider 8 for dividing the flow of the supplied precursor 7 into several parallel flows and thus for distributing it over a large part of the cross-sectional area of the internal space 3, but without unnecessarily directing the precursor 7 against the jacket 2.

The precursor 7 contains Si and C and is typically provided as a powder or granulate, for example as a SiO₂ powder with carbon-containing constituents such as graphite or carbon black. A nanoscale or microscale precursor is suitable, i.e. a precursor with nanoscale particles of primary particle sizes in the range from 5 to 1000 nm, typically about 20 to 200 or up to 1000 nm, or with microscale particles of primary particle sizes in the range from 1 to 1000 μm, typically about 1 or 20 to 200 μm. The precursor should have a purity corresponding to the required purity of the silicon carbide to be produced.

Below the outlet opening 5, there is a collection device 9 arranged for silicon carbide 10 that is produced in the reactor 1 from the precursor 7 and that exits or emerges from the internal space 3 through the outlet opening 5 due to gravity. The collection device 9 can be a container or a discharge device designed as a ramp or conveyor belt for the silicon carbide 10.

Since the reactor 1 is static, it can be sealed in a simple way so that the outside atmosphere does not enter into the internal space 3 filled with inert gas, for example by a seal between the feed opening 4 and the feed device 6 and a seal between the outlet opening 5 and the collection device 9 or by a casing around the reactor 1 (not shown).

The reactor 1 is heated and the jacket 2 has one or more heating devices 11, 12 for this purpose. Preferably, an upper first heating device 11 is provided for heating an upper first heating zone 13 of the internal space 3 to a first temperature, and a lower second heating device 12 is provided for heating a lower second heating zone 14 of the internal space 3 to a second temperature. In operation, the first temperature is in the range from about 1600 to 1900° C., preferably about 1800° C., and the second temperature is lower than the first temperature and is preferably in the range from about 1500 to 1700° C.

Thus, the precursor sinking from the feed opening 4 through the internal space is first exposed to the first temperature in the first heating zone 13, whereby the carbo thermal reactions are set in motion and intermediate products are formed, which react at the second temperature in the second heating zone 14 to form silicon carbide 10, which emerges from the outlet opening 5. The particles of the precursor 7 are thus transformed into nano- or microcrystalline particles of silicon carbide 10. The silicon carbide 10 is collected as a powder by the collection device 9.

The transport of the particles of the precursor 7 and silicon carbide 10 from the feed opening 4 through the internal space 3 to the outlet opening 5 essentially takes place in free fall under gravity. The particle size of the precursor and the lengths of the first zone 13 and the second zone 14 in the vertical direction are selected such that the sinking speed of the particles results in their dwell time, i.e. heating duration, of about 100 to 200 ms, preferably about 150 ms in the first heating zone 13 and a total dwell time of about 300 to 1000 ms, preferably about 400 ms in both heating zones 13, 14 or the entire internal space 3.

Optionally, baffle plates 15 can be provided which, as in the embodiment shown, project downwards from the jacket 2 into the first and/or the second heating zone 13, 14 of the internal space 3 and interrupt the fall of the particles of the precursor 7 and/or the silicon carbide 10 and thus extend the dwell time of the particles in the zones 13, 14 compared to a continuous free fall. The angle of inclination of the baffle plates 15 can be adjustable in order to adjust the dwell time. The dwell time can also be adjusted by allowing the inert gas in the internal space 3 to flow upwards to extend the dwell time or downwards to shorten the dwell time, for example by circulating the inert gas in a closed circuit which passes through the internal space 3 and through a return line (not shown) interconnecting the feed and outlet openings 4, 5 outside the reactor 1.

Within the heating zones 13, 14, the precursor 7 and the silicon carbide 10 are transported in free fall largely without contact with the jacket 2 and therefore largely without any contact, apart from contact with any baffle plates 15 provided. Therefore, the precursor 7 and the silicon carbide 10 do not absorb any impurities, and the silicon carbide 10 produced can be highly pure, corresponding to the purity of the precursor used. The jacket 2 and any baffle plates 15 provided are preferably made of silicon carbide or coated with silicon carbide towards the internal space 3 so as not to introduce any foreign substances into the silicon carbide 10 produced.

The apparatus is very robust as it has hardly any moving parts.

In operation, the apparatus allows an efficient continuous production method for the silicon carbide 10. In this method, the precursor 7 is supplied successively or continuously by means of the feed device 6 through the feed opening 4. The precursor falls through the heated internal space 3, i.e. specifically through the first and second heating zones 13, 14, as described above, and is transformed into silicon carbide 10. The silicon carbide falls out of the outlet opening 5 and is, also continuously, collected by the collection device 9.

1. An apparatus for the production of silicon carbide, comprising:
a reactor (1) which has on its upper side a feed opening (4) for continuous feeding with a precursor (7), on its lower side an outlet opening (5) for continuous exit of silicon carbide (10) formed from the precursor in the reactor (1), and between the feed opening (4) and the outlet opening (5) a heatable internal space (3), the feed opening, outlet opening and internal space arranged such that the precursor and silicon carbide, respectively, can pass through the internal space (3) falling from the feed opening (4) to the outlet opening (5).

2. An apparatus in accordance with claim 1, having a heating device (11, 12) for heating the internal space (3).

3. An apparatus in accordance with claim 2, wherein the heating device comprises a first heating device (11) for heating a first heating zone (13) of the internal space (3) to a first temperature and a second heating device (12) for heating a second heating zone (14) of the internal space (3) to a second temperature, the second heating zone located below the first heating zone (13) and the second temperature being lower than the first temperature.

4. An apparatus in accordance with claim 1, comprising a feed device (6) for continuously feeding the precursor (7) to the feed opening (4) and a divider (8) for distributing a flow of the precursor fed through the feed opening (4) into the internal space (3).

5. An apparatus in accordance with claim 1, with an inclined baffle plate (15) which projects into the flow of the precursor (7) or silicon carbide (10) falling through the internal space, to control the dwell time thereof in the internal space.

6. An apparatus in accordance with claim 5, wherein the angle of inclination of the baffle plate (15) is adjustable.

7. A method for producing silicon carbide by use of an apparatus according to claim 1, wherein:
the reactor (1) is continuously fed with precursor (7) through the feed opening (4),
the precursor (7) falls through the heated interior space (3) to the outlet opening (5) and is thereby transformed to silicon carbide (10), and
the silicon carbide (10) continuously emerging from the outlet opening (5) is collected.

8. A method in accordance with claim 7, wherein the precursor (7) is supplied in powder form.

9. A method in accordance with claim 7 or 8, wherein the silicon carbide (10) produced is in powder form.

10. A method in accordance with any of claim 7, wherein the precursor (7) and silicon carbide (10) pass through the heated internal space (3) substantially in free fall.
